(19) United States
(12) Patent Application Publication
(10) Pub. No.: US 2022/0400210 A1
(43) Pub. Date: Dec. 15, 2022

(54) IMAGE PROCESSING APPARATUS, IMAGE PICKUP APPARATUS, IMAGE PROCESSING METHOD, AND RECORDING MEDIUM

(71) Applicant: CANON KABUSHIKI KAISHA, Tokyo (JP)

(72) Inventor: Shinichi Maeta, Kanagawa (JP)

(21) Appl. No.: 17/745,992

(22) Filed: May 17, 2022

(30) Foreign Application Priority Data
Jun. 10, 2021 (JP) 2021-097123

(51) Int. Cl. H04N 5/232

(52) U.S. Cl. CPC H04N 5/232127; H04N 5/23218

(57) ABSTRACT

An image pickup apparatus acquires image data after image pickup, and depth information corresponding to an object in an image with respect to the image data and performs focus adjustment control of an imaging optical system based on focus detection results. The image pickup apparatus acquires information about an AF (auto focus) region during image capturing and determines a part of the region in the image to serve as a specific region. The image pickup apparatus performs evaluation of a focus state with respect to the image data based on the depth information corresponding to the AF region and the depth information corresponding to the specific region. The image pickup apparatus executes rating processing, and the rating data corresponding to the in-focus results of the AF region and the rating data corresponding to the in-focus results of the specific region are acquired to serve as evaluation information.

### BACKGROUND OF THE INVENTION

### Field of the Invention

The present invention relates to a technique for automatically evaluating image data obtained by image pickup based on focus detection results.

### Description of the Related Art

In an image pickup apparatus such as a digital camera, picked-up image data are obtained by an image-pickup element and various types of calculation processing are performed. In particular, an autofocus (AF) technique that uses phase difference information for signals that have been read out from the image-pickup element is well known. Various methods related to the readout of image-pickup elements have been proposed for realizing both readout that enables high-precision focus detection and readout that achieves low power consumption at a high speed.

A method for classifying and recording images according to the degrees of definition of a plurality of images is known as a method for classifying picked-up images. Japanese Patent Application Laid-Open No. 2004-320487 discloses a digital camera that can automatically select and store images with sharpness from among a plurality of frames of images that have been continuously shot. An AF evaluation value is acquired from each image obtained by performing continuous image capturing in a state in which the focus position is fixed, one image that has the highest AF evaluation value is automatically selected and recorded in a storage recording region, and unselected images are recorded in an erasing recording region. Japanese Patent Application Laid-Open Publication No. 2019-86775 discloses a technique for performing rating based on the in-focus state when a captured image is recorded. Still image data are evaluated based on the focus state of the still image data, the focus detection results are compared with a predetermined focus range, and rating is automatically performed for the image data obtained by image capturing according to the focus state. The user can classify the still image data based on the evaluation information.

In the technique disclosed in Japanese Patent Application Laid-Open No. 2004-320487, there may be cases in which an appropriate in-focus image cannot be selected. Since the continuous image capturing operation is performed in the state in which the focus position is fixed, a captured image having the highest AF evaluation value based on the high frequency component of the image can be estimated as the image having the best focus state. However, the image having the highest AF evaluation value is simply the image with the best focus state relative to the captured images that have been acquired. That is, the object intended by the user is not necessarily in focus.

Additionally, according to the technique disclosed in Japanese Patent Laid-Open No. 2019-86775, rating according to the focus state can only be performed for the object that corresponds to the focus position. However, there may be cases in which ratting cannot be performed according to the focus state for portions other than a specific object (for example, an object that is not the main object).

### SUMMARY OF THE INVENTION

According to the present invention, a focus state for a plurality of regions in an image is evaluated based on depth information related to the image and the work load of selecting and classifying image data is reduced.

An image processing apparatus according to the embodiments of the present invention is an image processing apparatus that acquires image data and depth information related to images and performs processing comprising: an acquisition unit configured to acquire information about a first region in an image with respect to the image data; a determination unit configured to determine a second region, which is different from the first region, to serve as a specific region, in the image; and a generation unit configured to evaluate a focus state with respect to the image data based on depth information corresponding to each of the first region and the second region, and generate a plurality of items of evaluation information, wherein one rating datum based on the plurality of items of evaluation information is recorded in association with one image.

Further features of the present invention will become apparent from the following description of exemplary embodiments with reference to the attached drawings.

### BRIEF DESCRIPTION OF THE DRAWINGS

FIG. 1 illustrates an example of a configuration of an image pickup apparatus according to the embodiments.

FIG. 2 illustrates an example of a configuration of an image-pickup element according to the embodiments.

FIG. 3 illustrates an example of a configuration of a pixel array of the image pickup element according to the embodiments.

FIG. 4A and 4B are schematic diagrams showing the relation between the imaging state and the phase difference in the image pickup element.

FIG. 5A and 5B illustrate phase difference detection.

FIG. 6 is a flowchart showing the process in the first embodiment.

FIG. 7 is a flowchart showing the process following the process in FIG. 6.

FIG. 8 illustrates an example of a configuration of an image processing apparatus according to the second embodiment.

FIG. 9 is a flowchart showing the process in the second embodiment.

FIG. 10 is a flowchart showing the process following the process in FIG. 9.

FIG. 11 is a flowchart showing the process in the third embodiment.

FIG. 12 is a flowchart showing the process following the process in FIG. 11.

FIG. 13 is a flowchart showing the process in the fourth embodiment.

FIG. 14 is a flowchart showing the process following the process in FIG. 13.

### DESCRIPTION OF THE EMBODIMENTS

Embodiments of the present invention will now be described in detail with reference to the drawings. In the embodiments, an example of an image pickup apparatus in which an image processing apparatus according to the present invention is applied is shown. The image pickup apparatus evaluates a focus state for a plurality of regions in an image, based on the depth information related to a picked-up image. An example is shown in which rating related to whether or not the object in the image is actually in focus is performed when image recording is performed after image capturing, based on the in-focus state. The burden of sorting and rating image data can be reduced h using the rating data that have been generated as the evaluation information.

### First Embodiment

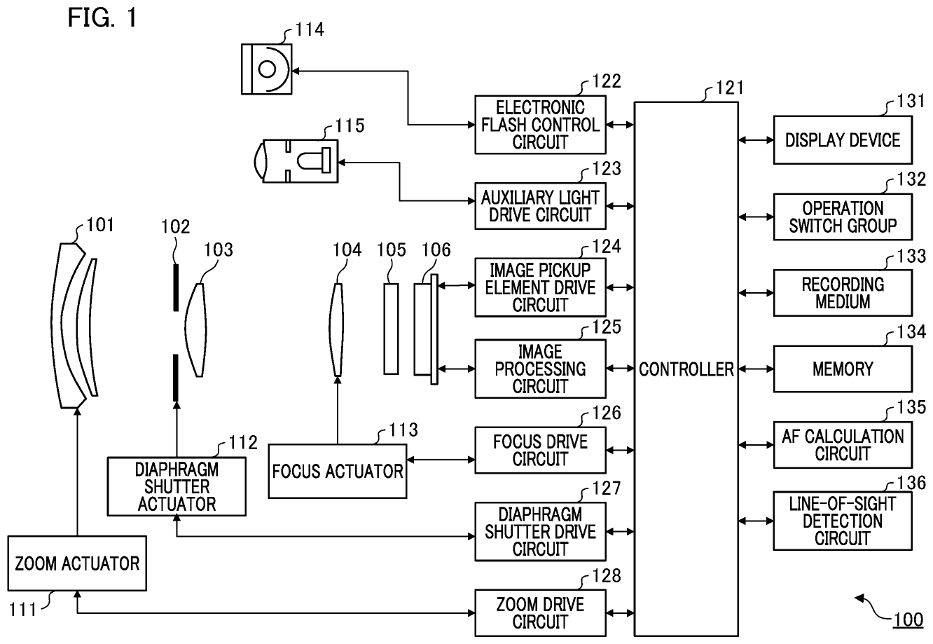

FIG. 1 is a block diagram illustrating a configuration of an image pickup apparatus according to the present embodiment. A digital camera is shown to serve as an example of an image pickup apparatus 100. In the description below, the object side is defined as the front side. A first lens group 101 is arranged at the front end of an imaging optical system. The first lens group 101 is held to be reciprocally movable in the optical axis direction. An aperture-and-shutter 102 adjusts an amount of light during image capturing by adjusting its aperture diameter, and also functions as a shutter for adjusting the exposure time when still images are captured. The aperture-and-shutter 102 and a second lens group 103 integrally and reciprocally move in the optical axis direction, and work in conjunction with the reciprocal movement of the first lens group 101, thereby realizing a magnification effect (zoom function).

A third lens group 104 is reciprocally movable in the optical axis direction and performs focus adjustment. An optical low-pass filter 105 is an optical element used to reduce false colors and moiré on the captured images. An image pickup element 106 has a two-dimensional CMOS (complementary metal-oxide-semiconductor) photosensor and peripheral circuits and is located on the imaging surface of the imaging optical system.

A zoom actuator 111 drives the first lens group 101 to the third lens group 104 in the optical axis direction by rotating a cam cylinder (not illustrated) and performs the magnification operation. A diaphragm shutter actuator 112 controls the aperture diameter of the aperture-and-shutter 102 to adjust a light amount of image capturing and also determines the exposure time when still images are captured. A focus actuator 113 drives the third lens group 104 in the optical axis direction and performs focus adjustment operations.

An electronic flash 114 for illuminating objects is provided with a flashlight illumination device in which a xenon tube is used or an illumination device in which an LED (light-emitting diode) that emits continuous light is used. An autofocus (hereinafter, referred to as “AF”) auxiliary light source 115 projects the image of a mask having a predetermined aperture pattern onto the object through the projection lens in order to improve the focus detection capability for dark objects or low-contrast objects.

A controller 121 is the central unit that performs various controls in the image pickup apparatus 100. The controller 121 has a CPU (central processing unit), an A/D converter, a D/A converter, a communication interface circuit, and the like (not illustrated).

An electronic flash control circuit 122 controls the lighting of the electronic flash 114 in synchronism with the image capturing operation. An auxiliary light drive circuit 123 controls the lighting of the AF auxiliary light source 115 in synchronism with the focus detection operation.

An image pickup element drive circuit 124 controls the image capturing operation of the image pickup element 106, and also performs A/D conversion on the image signals acquired by the image capturing, and transmits the converted signals to the controller 121. An image processing circuit 125 performs processing such as the detection of objects, gamma conversion, color interpolation and JPEG (Joint Photographic Experts Group) compression on the images obtained by the image pickup element 106.

A focus drive circuit 126 drives the focus actuator 113 based on the focus detection results and performs focus adjustment by driving the third lens group 104 in the optical axis direction. A diaphragm shutter drive circuit 127 changes the aperture of the aperture-and-shutter 102 by driving the diaphragm shutter actuator 112. A zoom drive circuit 128 drives the zoom actuator 111 in response to zoom operations performed by a photographer.

A display device 131 is configured by an LCD (liquid crystal display) or the like. The display device 131 displays information related to an image capturing mode of the image pickup apparatus 100, a preview image before image capturing, an in-focus state during focus detection, and the like.

An operation switch group 132 includes operation members such as a power switch, a release (image capturing trigger) switch, a zoom operation switch, and an image capturing mode selection switch. For example, there is a first switch (hereinafter, referred to as “SW1”) for providing an instruction to start photographing preparation operation, and a second switch (hereinafter, referred to as “SW2”) for providing an instruction to start image capturing operation after SW1 is pressed.

A recording medium 133 is a flash memory or the like that can be attached to and removed from the image pickup apparatus 100, and records information including image files obtained by image capturing. A memory 134 has a RAM (random access memory), a ROM (read-only memory), and the like. The memory 134 performs, for example, the storage of a program, and the holding of image data during image processing and parameter data necessary for the image processing.

An AF calculation circuit 135 performs focus detection based on the image signals output from the image pickup element 106 and outputs the AF calculation results to the controller 121. A line-of-sight detection circuit 136 detects a line-of-sight position when the user views a viewfinder unit (not illustrated). The detection of the line-of-sight position is performed by projecting infrared light onto an eyeball by using a line-of-sight detection LED (not illustrated) and receiving the reflected light by using an eye detection sensor (not illustrated). The line-of-sight detection circuit 136 outputs the results of the line-of-sight detection to the controller 121.

The controller 121 drives various circuits of the image pickup apparatus 100 based on the programs stored in the ROM of the memory 134 and performs a series of operation controls such as AF, image capturing, image processing, and recording.

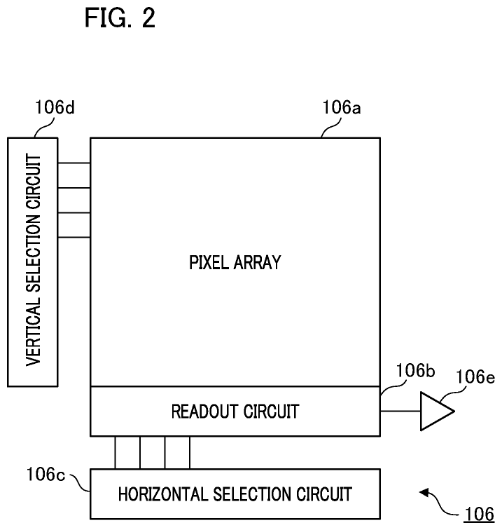

A configuration of the image pickup element 106 will be described with reference to FIG. 2. FIG. 2 is a block diagram illustrating an example of a configuration of the image pickup element 106. The image pickup element 106 is provided with a pixel array 106a, a readout circuit 106b, a horizontal selection circuit 106c, a vertical selection circuit 106d, and an amplifier 106e. The pixel array 106a has a configuration in which pixel groups are arranged in a two-dimensional array. The vertical selection circuit 106d selects a row in the pixel array 106a. The horizontal selection circuit 106c selects a column in the pixel array 106a. The readout circuit 106b reads out the signals of the pixels selected by the vertical selection circuit 106d and the horizontal selection circuit 106c from among the multiple pixels that configure the pixel array 106a.

The vertical selection circuit 106d selects a row of the pixel array 106a and enables a readout pulse that is output from the image pickup element drive circuit 124 in the selected row based on the horizontal synchronization signals output from the controller 121. The readout circuit 106b has an amplifier and a memory for each column, and the pixel signals of the selected row are stored in the memory via the amplifier. The pixel signals for one row stored in the memory are sequentially selected in the column direction by the horizontal selection circuit 106c and are externally output via the amplifier 106e. This operation is repeated for the number of rows and all pixel signals are externally output.

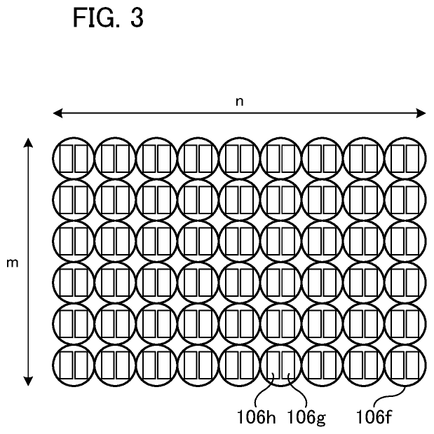

FIG. 3 illustrates a configuration example of the pixel array 106a. A configuration example is shown in which the pixel array 106a is provided with a plurality of pixel portions for outputting two-dimensional image data and phase difference detection is possible. FIG. 3 illustrates a pixel group having m rows and n columns in the pixel array 106a.

In FIG. 3, a micro lens 106f, which is shown by a circular frame, is provided with a plurality of photodiodes (hereinafter, referred to as “PD”) 106g and 106h, which are shown by rectangular frames. The PDs 106g and 106h configure a plurality of photoelectric conversion units. That is, one micro lens is located at the front side (object side) of the two photoelectric conversion units that configure each pixel unit. A region sharing one micro lens 106f is defined as one pixel, and the n pixels are arranged in the horizontal direction and the in pixels are arranged in the vertical direction. It is possible to add and read the first signal stored in PD 106g and the second signal stored in the PD 106h according to the operation setting of the vertical selection circuit 106d. It is also possible to read out either the first signal or the second signal, or to read out both signals independently. Light from each different image having phase differences becomes incident on the PD 106g and the PD 106h. Hereinafter, a pixel configured by the PD 106g is referred to as an “A image pixel”, and a pixel configured by the PD 106h is referred to as an “B image pixel”.

In the present embodiment, although a configuration example in which two PDs are arranged for one micro lens is shown, a configuration in which three or more PDs (for example, four PDs, nine PDs, or the like) are arranged for one micro lens may be adopted. For example, the present invention can be applied to a configuration in which a plurality of PDs is arranged in the vertical direction or the horizontal direction for one micro lens.

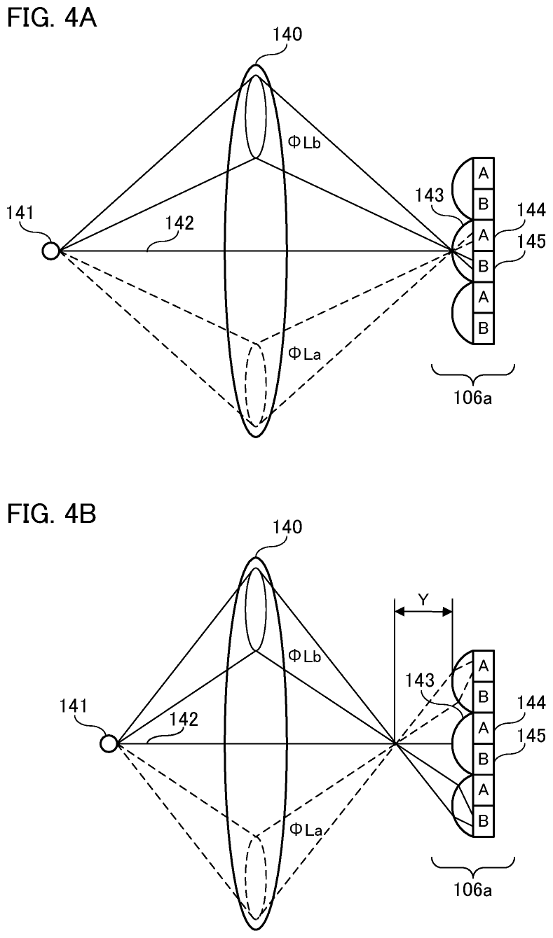

Next, with reference to FIGS. 4A and 4B, the pixel data output from the A image pixel and the B image pixel in e image pickup element 106 will be described. FIGS. 4A and 4B are schematic diagrams showing the relation between the imaged state and the phase difference in the image pickup element 106. An image capturing lens 140 in the drawings corresponds to an imaging optical system that is represented by the first lens group 101, the second lens group 103, and the third lens group 104 shown together in FIG. 1 as a single lens.

In the cross-section of the pixel array 106a shown in FIGS. 4A and 4B, a pair of an A image pixel 144 and a B image pixel 145 are arranged for one micro lens 143. The light from an object 141 passes through the different pupil partial regions of the image capturing lens 140 with an optical axis 142 as the center and forms an image on the image pickup element 106. In this context, the center of the exit pupil and the center of the image capturing lens are the same. Light passes through each of the partial pupil regions of the image capturing lens 140 from different directions. Specifically, in the present configuration, the pupil region when the pupil of the imaging optical system is viewed from the A image pixel and the pupil region when the pupil of the imaging optical system is viewed from the B image pixel are symmetrical, and the pupil of the imaging optical system is divided symmetrically. In other words, the beam of light from the imaging optical system is divided into two beams of light, and what is referred to as “pupil division” is performed. The light beams obtained by pupil division are denoted as the first light beam ΦLa and the second light beam ΦLb. Light from each different direction becomes incident on the A image pixels and B image pixels.

The first light beam ΦLa, which is from a specific point on the object 141, is a light beam that becomes incident on the A image pixel 144 through a first pupil partial region. The second light beam ΦLb, which is from a specific point on the object 141, is a light beam that becomes incident on the B image pixel 145 through a second pupil partial region. The two light beams ΦLa and ΦLb obtained by pupil division correspond to light that is incident from the same point on the object 141 through the imaging optical system.

FIG. 4A illustrates a state in which the focus of the imaging optical system matches the object 141 (in-focus state). In this state, the light beams ΦLa and ΦLb pass through the same micro lens 143 and reach a point on the image pickup element. Therefore, the phases of the image signals obtained from the A image pixels 144 and the B image pixels 145 match each other.

In contrast, FIG. 4B illustrates a state in which the focus point is shifted by a distance Y in the optical axis direction. In this state, the arrival positions of the light corresponding to each of the light beams ΦLa and ΦLb shift together by the degree of change of their angle of incidence on the micro lens 143. Hence, a phase difference occurs in the image signals obtained from each of the A image pixels 144 and the B image pixels 145. The PDs corresponding to each pixel respectively perform photoelectric conversion on the two object images (A image and B image) each of which have a phase difference and were detected by the A image pixel 144 and the B image pixel 145. The A image signal and B image signal are independently externally output after photoelectric conversion and are used in the AF control to be described below.

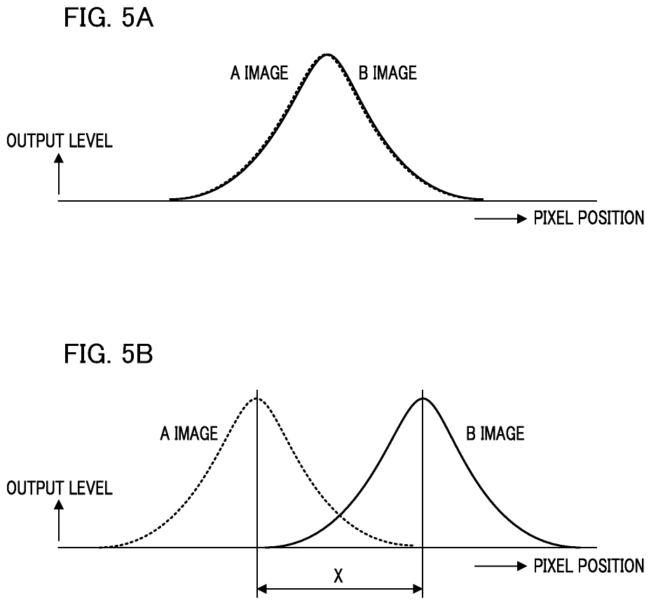

A description will be given of phase difference detection with reference to FIGS. 5A and 5B. In FIGS. 5A and 5B, the horizontal axis represents the pixel position, and the vertical axis represents the output level of the image pickup element. FIG. 5A illustrates the A image data and the B image data when the object is in focus as described in FIG. 4A. In this case, the A image data and B image data match.

In contrast, FIG. 5B illustrates the A image data and B image data when the object is not in focus as described in FIG. 4B. In this case, a phase difference exists between the A image data and the B image data, and a shift amount X is generated at the pixel position. The AF calculation circuit 135 calculates the image shift amount, that is, the Y value in FIG. 4B, by calculating the shift amount X for each of the moving image frames. The controller 121 transmits a control signal corresponding to the data for the Y value calculated by the AF calculation circuit 135 to the focus driving circuit 126.

The focus driving circuit 126 receives control signals and calculates a drive amount for the third lens group 104 based on the data of the Y value that has been acquired from the AF calculation circuit 135. Drive control of the focus actuator 113 is performed according to the drive amount. The focus actuator 113 moves the third lens group 104 to the position where the object is in focus (in-focus position), and a state in which the focus point is positioned on the light receiving surface of the image pickup element 106 is obtained.

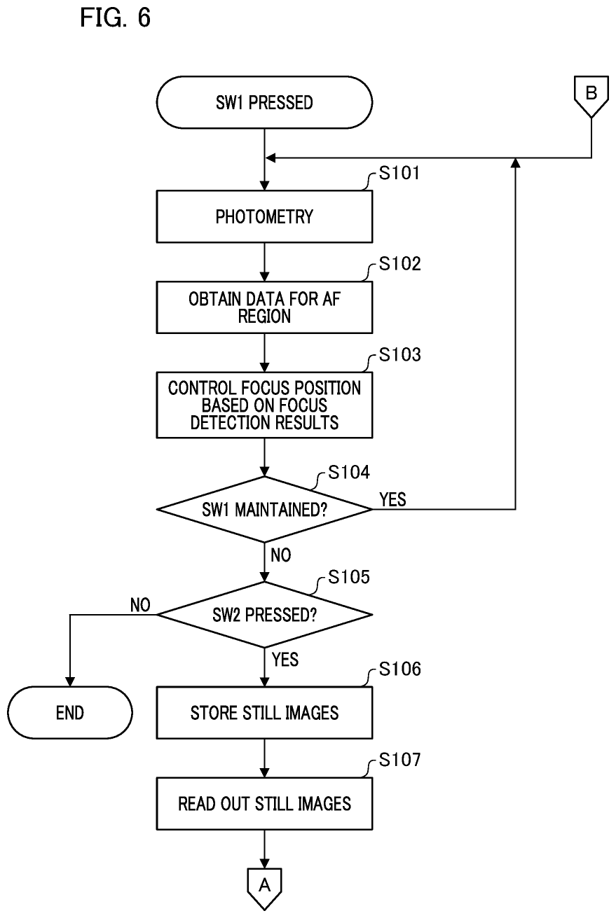

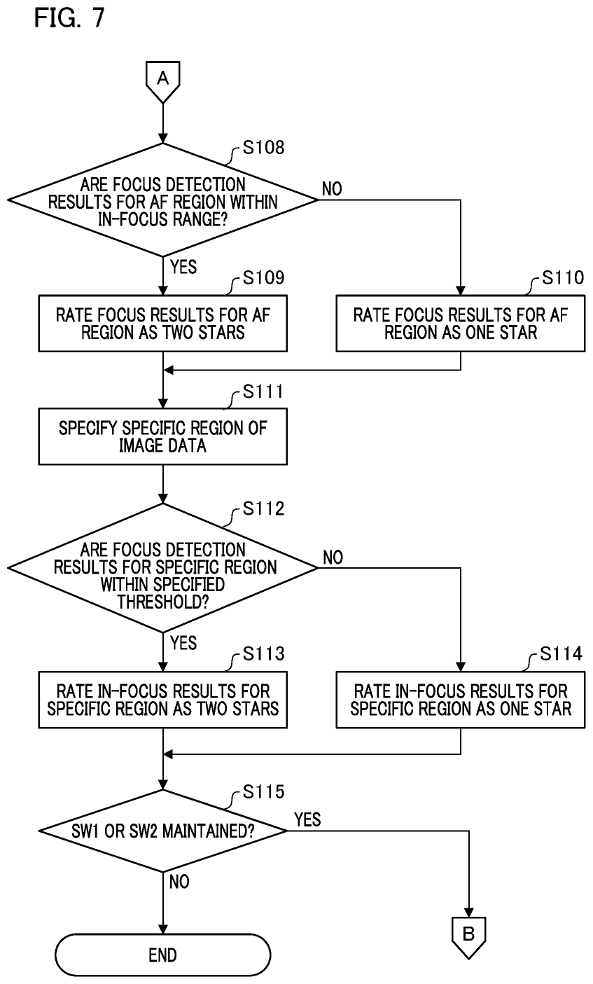

Next, image capturing and image reproduction, which are performed by the image capturing apparatus 100, will be described with reference to FIGS. 6 and 7. FIG. 6 and FIG. 7 are flowcharts showing the image capturing operation and image rating processing performed by the image pickup apparatus 100. The process below is realized by the controller 121 that controls each unit. When the user presses the SW1, which is included in the operation switch group 132, the process starts and proceeds to S101.

In S101 of FIG. 6, photometry is performed, and the photometry results are obtained. Next, the process proceeds to S102, in which the controller 121 performs the focus detection processing, which detects a defocus amount of the third lens group 104 based on the signals acquired by the image pickup element 106. After the defocus amount is acquired as a result of the focus detection, the process proceeds to S103.

In S103, the controller 121 calculates a focus drive amount, which is a drive amount of the third lens group 104, based on the defocus amount acquired in S102. The controller 121 transmits a control signal corresponding to the calculated focus drive amount to the focus drive circuit 126. The focus drive circuit 126 controls the focus position of the third lens group 104 through the focus actuator 113 based on the received control signals. After the control of the focus position, the process proceeds to S104.

In S104, the controller 121 detects the operation input state of the SW1 and determines whether or not the SW1 has continued to be maintained or not. If the controller 121 determines that the SW1 has continued to be maintained, the process returns to S101, photometry is performed again, and subsequently the focus detection processing is executed. If the controller 21 determines that the SW1 has not continued to be maintained, the process proceeds to S105.

In S105, the controller 121 detects the operation input state of the SW2 and determines whether or not the SW2 is being pressed or not. If the controller 121 determines that the SW2 is being pressed, the process proceeds to S106. If the controller 121 determines that the SW2 is not being pressed, it is considered that the SW1 and SW2 have been released, and the process of the present embodiment ends.

In S106, in order to perform a still image capturing operation, exposure of the image pickup element 106 starts based on the setting of the charge accumulation time and the setting of the ISO sensitivity determined based on the results of the photometry in S101, and charges are accumulated. The exposure time is controlled by the diaphragm shutter actuator 112. At this time, the image pickup element 106 is controlled by the image pickup element drive circuit 124 in a drive mode in which signals are read out from the region including the entire effective pixel region of the image pickup element 106.

In S107, image signals corresponding to the electric charges accumulated in the image pickup element 106 are acquired by the image pickup element drive circuit 124, and after A/D conversion, RAW data, which are image data obtained by pupil division, are generated. The RAW data are the data from before the image processing including development has been applied and they are transferred to the memory 134. In addition, predetermined image processing is performed by the control of the controller 121 and still image data are generated in a known file format (for example, JPEG format file). After the controller 121 performs control to record the RAW data and the still image data in a known file format on the recording medium 133, the process proceeds to S108 in FIG. 7.

In S108, the controller 121 determines whether or not the defocus amount calculated by focus detection is within a predetermined in-focus range. Specifically, the controller 121 determines whether or not the RAW data and the still image data obtained in S107 are the image data in which the intended object is in focus. For example, when the aperture value is denoted by “F” and the permissible confusion circle diameter is denoted by “δ [μm]”, the predetermined in-focus range is in the range of −1 Fδ to +1 Fδ [μm]. A threshold for the range of the focus position defined by the defocus amount is set in advance. If the defocus amount obtained in S102 is within the predetermined focus range, it is determined that the RAW data and the still image data obtained in S107 are the data for an image in which the intended object is in focus, and the process proceeds to S109. When the defocus amount obtained in S102 is not within the predetermined in-focus range, it is determined that the RAW data and the still image data obtained in S107 are blur image data in which the intended object is not in focus, and the process proceeds to S110.

In addition to the method for determining whether or not the defocus amount is within a predetermined in-focus range, there is a method in which an image is determined to be in-focus when the absolute value of the defocus amount is less than a predetermined threshold, and an image is determined to be out-of-focus when the absolute value of the defocus amount is equal to or higher than the predetermined threshold. The present invention is not limited to this method, and any method may be adopted if, in the method, the focus state can be determined based on information corresponding to the focus state. For example, there is a method for determining the focus state by determining whether or not the image shift amount described above is within a predetermined threshold range. The methods described above can also be adopted in the embodiments to be described below.

In S109, the controller 121 evaluates the RAW data and still image data which have been transferred to the memory 134 and the recording medium 133 in S107, based on the focus detection results. For example, rating processing based on the absolute value of the defocus amount is performed. The results of this rating, that is, the data that represent the rating, is recorded as the data of a first attribute region of the RAW data and the still image data.

In an image file, the attribute region in the present embodiment is a recording region in which editing can be performed by the user even after the image capturing operation, instead of the image data region consisting of binary data. Since the user can easily edit the rating data when he/she wants to manually perform rating or wants to modify the recorded rating data later, the work efficiency can be enhanced. As the methods for performing recording in the attribute region in which editing can be performed after the image capturing operation, for example, if the still image data in the JPEG format are recorded, there are the methods below.

A method for writing in “APP1”, which is a marker segment in the JPEG format indicating attribute information. (See ISO/IEC 10918-1: 1994)
A method for writing in the “MakerNote”, which is the manufacturer's own use column, in the Exif format (general incorporated association, Camera & Imaging Products Association, Image File Format Standard for Digital Still Cameras) Exif 2.31 (refer to ((CIPA DC-008-2016))

In either of these two writing methods, it is possible to write the rating according to recording specifications configured with XML text data. The results of the rating can be read out by image editing software made by third-party organizations with a certain degree of compatibility. Regarding the recording specifications, refer to “Extensible Metadata Platform (XMP) Specification “Part 1-Part 3, Adobe Systems Incorporated. In the JPEG file format and Exif format, regions are divided into a plurality of segments with a two-byte marker used as a mark, so that the content of the attribute information to be recorded can be identified according to the value of the marker to be used. Such a recording manner in which data columns of various items of information are separated by marker segments is used in not only the MEG format but also the Tag image File Format (TIFF) and other image file formats.

In the present embodiment, as an example of the rating, a case is described in which two stars are set when the object is in-focus and one star is set when the object is out-of-focus. That is, the evaluation information is distinguished by the number of stars. The evaluation information can be presented to the user on the display device 131 together with the images. Note that, in order to distinguish the image data for which rating has not been performed from the image data in which the object is in an out-of-focus state, the out-of-focus state is intentionally not treated as being set to have no stars. These matters are the same in the embodiments to be described below.

When the process proceeds from S108 to S109, that is, when the calculated defocus amount is within a predetermined in-focus range, the controller 121 performs control to record the rating data with two-stars in the first attribute region. After the rating data are recorded, the process proceeds to S111. When the process proceeds from S108 to S110, that is, when the calculated defocus amount is outside of a predetermined in-focus range, the controller 121 performs control to record the rating data with one star in the first attribute region. Thus, in the present embodiment, the controller 121 evaluates the still image data based on the focus detection state of the obtained still image data, and records information corresponding to the evaluation (evaluation information) in association with the still image data. After the rating data are recorded, the process proceeds to S111.

In S111, the user operates the operation switch group 132 and specifies a region (specific region) in the RAW data and still image data that have been obtained, for which they would like to determine whether or not an in-focus state has been attained. In S112, the controller 121 determines whether or not the defocus amount calculated as the focus detection results for the specific region specified in S111 is within the specified threshold range, as in S108. Specifically, the controller 121 determines whether or not the RAW data and the still image data obtained in S107 are image data in which the region specified by the user is in focus. If it is determined that the calculated defocus amount is within the specified threshold range, the process proceeds to S113, and if it is determined that the calculated defocus amount is not within the specified threshold range, the process proceeds to S114.

In S113, as in S109, the controller 121 performs rating for the RAW data and the still image data that have been transferred to the memory 134 and the recording medium 133 in S107, based on the absolute value of the defocus amount in the specific region specified by the user in S111. The controller 121 performs control to record the rating data obtained as a result of the rating in the second attribute region of the RAW data and the still image data. The rating processes in S113 and S114 is the same as those in S109 and S110.

In S313, the controller 121 performs control to record the rating data with two-stars in the second attribute region, and subsequently the process proceeds to S115. Additionally, in S114, the controller 121 performs control to record the rating data with one-star in the second attribute region, and subsequently the process proceeds to S115. As described above, in the present embodiment, the controller 121 evaluates the still image data based on the focus detection state of two or more regions with respect to the obtained still image data d records the evaluation information in association with the still image data.

In S115, the controller 121 determines the operation input states of the SW1 and the SW2. That is, determination processing is performed as to whether or not an operation input has been made such that the SW2 is being pressed and the continuous shooting is continued or as to whether or not an operation input is made such that the SW1 is being pressed and the focus position is controlled again. When it is determined that the SW1 is being maintained or the SW2 is being pressed, the process returns to S101 in FIG. 6 and the process continues, and focus detection is performed again. When it is determined that the SW1 is not being maintained or the SW2 is not being pressed, the process for appropriately classifying and recording the image capturing results ends, and the operations of the present embodiment end.

As described above, according to the present embodiment, the controller 121 can evaluate still image data based on the focus detection state of the obtained still image data and classify the still image data according to the evaluation information. Consequently, the images can be classified according to the focus detection state for the images that have been actually captured, and the burden of classifying the captured image data can be reduced.

In the present embodiment, a method in which the user specifies a region for which they would like to determine whether or not an in-focus state has been attained in the RAW data and the still image data by using an operation switch, a touch panel, or the like, is shown. The present invention is not limited thereto, and the method for specifying a region for which the user would like to determine whether or not an in-focus state has been attained in the RAW data and the still image data by using the user's line-of-sight position that has been detected by the line-of-sight detection circuit 136, may be adopted. There is also a method in which image pickup apparatus 100 automatically determines a region including an object that has been detected by the object detection processing unit to serve as a region to be determined whether or not the in-focus state is attained, in addition to the AF region. The object detection processing can be realized by a known detection method, for example, by the CPU of the controller 121 executing a program. These matters are the same for the embodiments to be described below.

### Second Embodiment

Next, the second embodiment of the present invention will be described. In the first embodiment, an example is shown in which the controller 121 performs the main control such that focus detection is performed inside the image pickup apparatus 100. In contrast, in the present embodiment, a description will be given of an example in which focus detection is performed by executing a software program in a device external to the image pickup apparatus 100, and rating is performed for the image data according to the focus detection state based on the focus detection results. Note that, in the present embodiment, the matters that are the same as those in the first embodiment will be omitted, and mainly the differences will be described. The same method of omission is also used in the embodiments to be described below.

In the present embodiment, the recording medium 133 of the image pickup apparatus 100 is connected to an external apparatus, focus detection is performed based on the RAW data according to the software on the computer of the external apparatus, and the image rating processing is performed through the software according to the focus detection results. In the recording medium 133 that can be attached to and removed from the main unit of the apparatus, the RAW data corresponding to the signals of focus detection pixels obtained by pupil division are stored. Furthermore, in the recording medium 133, the data for the aperture value during image capturing, the data for the reference lens driving amount at the focus position during recording, and the data for the variable magnification at the focus position during recording are respectively stored in association with the RAW data.

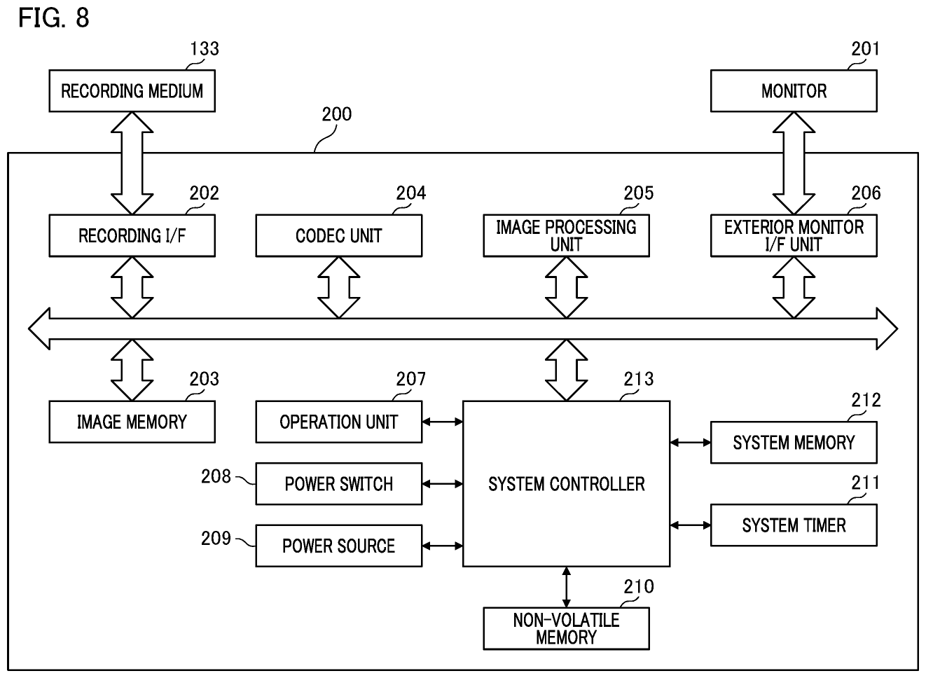

FIG. 8 is a block diagram illustrating a personal computer (hereinafter, referred to as a “PC”) 200 and peripheral apparatuses thereof to serve as an example of the external apparatus according to the present embodiment. The recording medium 133 that can be attached to and removed from the PC 200, and a monitor 201 are shown as the peripheral apparatuses. The PC 200 has the function of classifying or sorting the image data obtained by the image pickup apparatus 100.

A system controller 213 receives instructions for reading image data from the recording medium 133 through the operation of an operation unit 207 performed by the user. The operation unit 207 has a pointing device, a keyboard, a touch panel, and the like. The process of loading onto the image data recorded on the recording medium 133 into an image memory 203 is executed via a recording interface (I/F) unit 202 in accordance with the instructions from the user's operation.

If the image data read from the recording medium 133 are compression coded data, the system controller 213 transmits the image data from the image memory 203 to a codec unit 204. The codec unit 204 decodes the compressed coded image data and outputs the decoded image data to the image memory 203.

The system controller 213 outputs decoded image data stored in the image memory 203 or uncompressed image data such as Bayer ROB format (RAW format) data to an image processing unit 205. The image processing unit 205 performs image processing on the image data and performs processing for storing the data from the image processing results in an image memory 203. The system controller 213 reads out the image data after image processing from the image memory 203 has been completed and outputs the image data to the monitor 201 via an external monitor interface (I/F) unit 206.

The PC 200 has a power switch 208, a power source 209, a non-volatile memory 210 that is electrically erasable and recordable, a system timer 211, and a system memory 212. The system timer 211 is a device that measures the time used for various controls and the time of a built-in clock. In the system memory 212, for example, constants and variables for the operation of the system controller 213 and programs read from the non-volatile memory 210 are loaded.

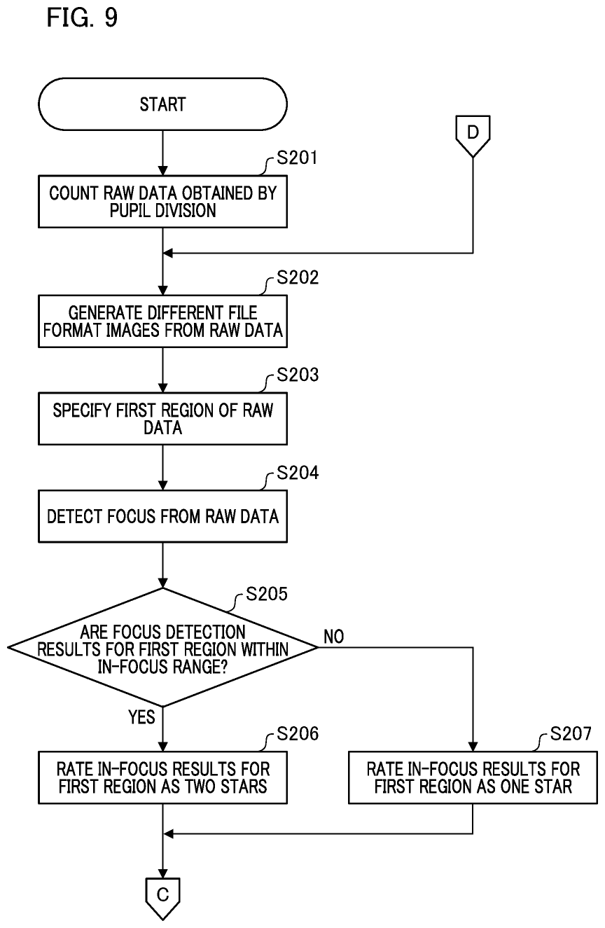

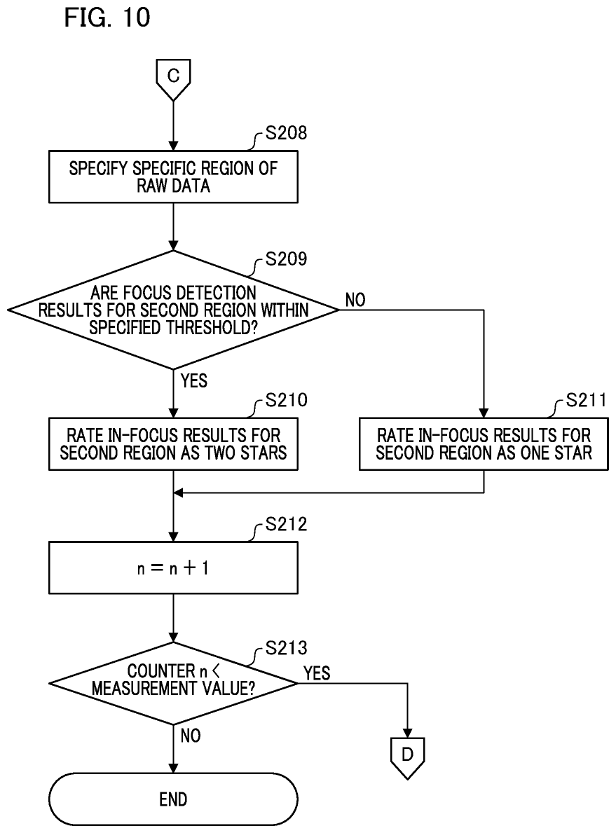

The process in the present embodiment will be described with reference to FIG. 9 and FIG. 10,. FIG. 9 and FIG. 10 are flowcharts showing the image rating processing in the PC 200. The process below is realized by the system controller 213 performing control so that the program read out from the non-volatile memory 210 is loaded by the system memory 212 and each processing step of software is executed.

In the initial state immediately after startup, the PC 200 and the recording medium 133 of the image pickup apparatus 100 are electrically connected and communicable. The system controller 213 can read out various data recorded on the recording medium 133. When the user performs an operation input for starting the image rating processing by the software on a display screen, the system controller 213 receives the operation input, and the process proceeds to S201.

In S201, all links to the RAW data of the image data specified by the user are read out and temporarily stored in a memory (not illustrated) in the PC 200. The system controller 213 counts the number of RAW data temporarily recorded on the recording medium 133. After counting, the process proceeds to S202.

In S202, the system controller 213 determines one from among the RAW data (hereinafter, referred to as “data of interest”) based on the links to the RAW data that have been temporarily recorded in S201, and performs the read processing of the data of interest. Various types of image processing including development processing are applied to the data of interest and still image data in a known file format corresponding to the data after image processing are generated. In S203, when the user specifies the first region of the data of interest, the system controller 213 receives the operation input of this specification.

In S204, focus detection is performed on the first region with respect to the data of interest specified in S203. Specifically, the system controller 213 performs readout processing on the data of the signal of the focus detection pixel obtained by pupil division, the aperture value during recording, the reference lens driving amount, and the variable magnification of the reference lens driving amount, of the data of interest by executing a software program. Subsequently, an image region corresponding to the first region is extracted from the data of interest, and a correlation amount for each phase shift amount in each focus detection pixel row of the extracted image region is calculated. After the correlation amount for each shift amount is calculated, the phase difference with the highest correlation amount (also referred to as the “image shift amount”) is calculated. After the phase difference is calculated, the defocus amount is calculated based on the phase difference value, the aperture value, and the reference defocus amount using a known phase difference detection system. After the defocus amount is calculated, the process proceeds to S205.

In S205, the system controller 213 determines whether or not the defocus amount calculated, which corresponds to the first region of the data of interest, is within a predetermined in-focus range (For example, −1 Fδ to +1 Fδ [μm]). If it is determined that the defocus amount in the first region is within the predetermined in-focus range, the process proceeds to S206. If it is determined that the defocus amount is not within the predetermined in-focus range, the process proceeds to S207.

In S206, the system controller 213 performs rating on the still image data corresponding to the first region with respect to the data of interest based on the absolute value of the defocus amount calculated in S204. The rating data obtained as a result of this rating are recorded in the first attribute region of the RAW data and the still image data. In addition, in the present embodiment, the attribute region is the region described in S109 in FIG. 7 in the first embodiment and is a region to which editing can be easily performed by the user after the image capturing operation has been completed. The contents of the rating processing are the same as those in the first embodiment.

In S206, the system controller 213 performs control to record the rating data with two-stars in the first attribute region, and subsequently the process proceeds to S208 in FIG. 10. Additionally, in S207, the system controller 213 performs control to record the rating data with one-star in the first attribute region, and subsequently the process proceeds to S208 in FIG. 10. Thus, the system controller 213 evaluates the still image data based on the focus detection state of the still image data and performs control to record the evaluation information in association with the still image data.

In S208, when the user specifies a second region, which is separate from the first region specified in S203, in the data of interest, the system controller 213 receives an operation input corresponding to the specification. In S209, the system controller 213 determines whether or not the defocus amount calculated according to the second region for the data of interest specified in S208 is within the specified threshold range (for example, −1 Fδ to +1 Fδ [μm]). If it is determined that the defocus amount in the second region is within the specified threshold range, the process proceeds to S210, and if it is determined that the defocus amount is not within the specified threshold range, the process proceeds to S211.

In S210, the system controller 213 performs rating based on the absolute value of the defocus amount calculated in S204 on the still image data corresponding to the second region for the data of interest. The rating data obtained as a result of this rating are recorded in the second attribute region of the RAW data and the still image data. The contents of the attribute region and the rating processing are the same as those in the first embodiment.

In S210, the system controller 213 performs control to record rating data with two-stars in the second attribute region, and subsequently the process proceeds to S212. Additionally, in S211, the system controller 213 performs control to record rating data with one-star in the second attribute region, and subsequently the process proceeds to S212. Thus, the system controller 213 evaluates the still image data based on the focus detection states of two or more regions of the still image data and performs control to record the evaluation information in association with the still image data.

In S212, the system controller 213 performs processing for adding incrementing) 1 to the value of the counter variable (denoted by “n”) of the RAW data for which the focus detection has been completed, and subsequently the process proceeds to S213. In S213, the system controller 213 compares the value of the counter variable n of the RAW data for which focus detection has been completed with the number of RAW data counted in S201, that is, the count value, and determines the difference between the values. If the value of the counter variable n is less than the count value, the image processing and focus detection need to be performed on the RAW data for which this has not yet been performed, and the process returns to S202 to continue the process. The above processes are repeatedly executed for all of the RAW data that has been temporarily recorded. In contrast, when the value of the counter variable n is equal to or higher than the count value, it is determined that all of the RAW data stored in the specified folder of the recording medium 133 of the image pickup apparatus 100 have been read out, and the operations of the present embodiment end.

According to the present embodiment, focus detection is performed in an external apparatus of the image pickup apparatus, and rating processing is performed based on the focus detection results. It is possible to reduce the processing load during the image capturing operation by the image pickup apparatus by performing the rating processing by the external apparatus and it is possible to classify the still image data based on the evaluation information. Since the images of the actually captured image data can be classified according to the focus detection state, the workload of classifying the image data can be reduced.

Additionally, according to the present embodiment, an example in which the recording medium of the image pickup apparatus and the external apparatus (computer) are electrically connected so as to establish a communicable state is shown. The present invention is not limited to this example, and a configuration in which a communicable state is established by electrically connecting a readout device for reading out data from the recording medium of the image pickup apparatus and the external apparatus may be adopted. Additionally, there is a configuration in which a state in which a wireless communicable state is established by providing a readout device for reading data from the recording medium of the image pickup apparatus and a wireless communication means in the external apparatus, instead of connection by wired communication.

### Third Embodiment

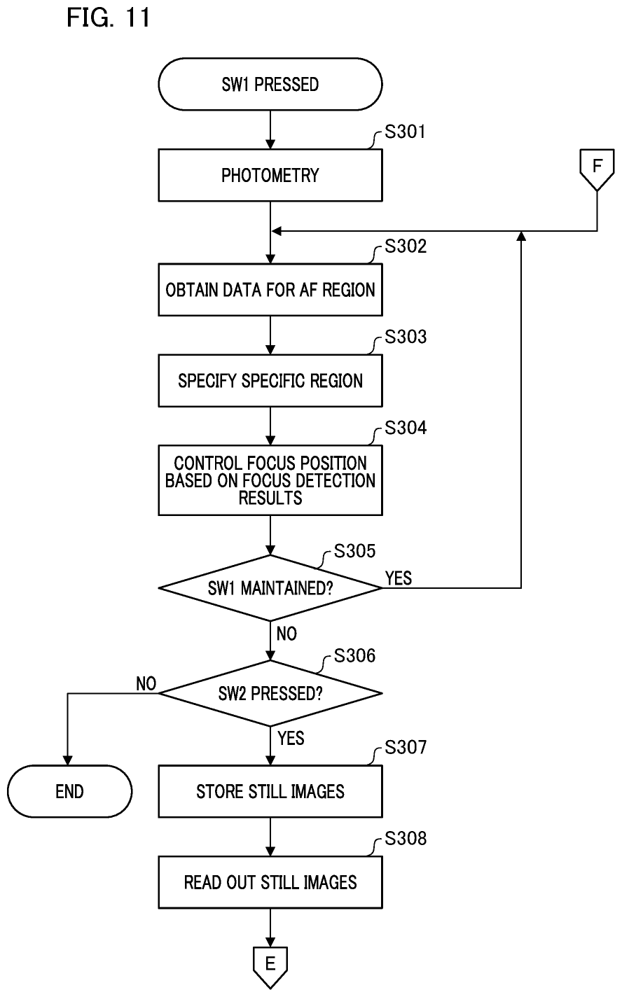

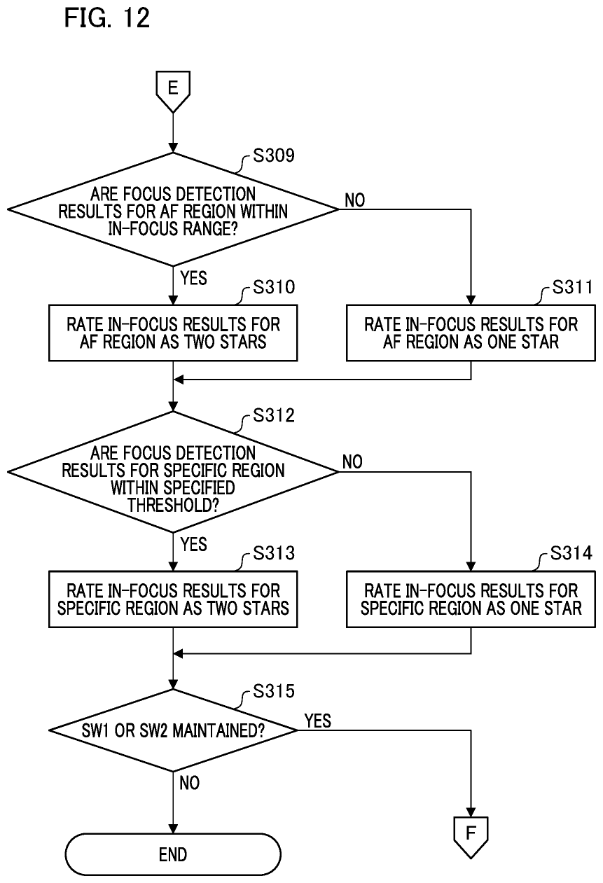

The third embodiment of the present embodiment will be described with reference to FIG. 11 and FIG. 12. In the above embodiments, focus detection is performed on the entire range of image data in order to detect a defocus amount. In order to perform focus detection on the entire range of the image data, a range in which focus detection is unnecessary is also a target for processing, and therefore a readout time from the image pickup element 106 and a time for calculating the defocus amount are necessary. Accordingly, in the present embodiment, an example of acquiring defocus information only for a range in which focus detection is necessary will be described.

FIGS. 11 and 12 are flowcharts for explaining the image pickup operation and the image rating processing in the present embodiment. When the user presses the SW1, the process starts and proceeds to S301. The processes of S301 and S302 are respectively the same as those of S101 and S102 in FIG. 6, and therefore, descriptions thereof will be omitted. After S302, the process proceeds to S303.

In S303, the user operates the operation switch group 132 to specify a region (specific region) in the acquired RAW data and still image data for which they would like to determine whether or not an in-focus state has been attained. The focus detection is performed based on the signal acquired from the image pickup element 106 according to the specified region, and the defocus amount is calculated as a result of the focus detection. Since the processes from S304 to S311 are respectively the same as those from S103 to S110 in FIG. 6 and FIG. 7, descriptions thereof will be omitted. After S310 or S311, the process proceeds to S312.

In S312, the controller 121 determines whether or not the defocus amount, which has been calculated as the focus detection results, of the region (specific region) specified in S303 is within the specified threshold range. Specifically, the controller 121 determines whether or not the RAW data and the still image data acquired in S307 are image data in which the region specified by the user is in-focus. Since the processes from S312 to S315 are respectively the same as those from S112 to S115 in FIG. 7, descriptions thereof will be omitted.

In the present embodiment, a process for acquiring defocus information is performed only in the range where focus detection is necessary by the user specifying a region to be a target for focus detection before the still image capturing operations. Therefore, it is possible to reduce the time required to read out signals from the image pickup element 106 and calculate the defocus amount.

### Modification of Third Embodiment

In the third embodiment, an example of performing focus detection based on the signals acquired from the image pickup element 106 and calculating a defocus amount as a result of focus detection is shown. In the modification, distance information to an object is acquired by the ToF (Time of Flight) method. In the ToF method, the distance information can be acquired by measuring the time until the infrared pulse projected to the object returns after being reflected.

Additionally, in the modification, the contrast information of the image data acquired by the image pickup element 106, that is, the contrast evaluation value, is calculated, and the defocus amount is acquired based on the evaluation value. Alternatively, in another modification, the defocus amount is acquired based on distance map data using the DFD (Depth From Defocus) method.

In the third embodiment, for example, the AF region is fixed at one position, such as the center of the field angle of the captured image. In the modification, the focus detection can be performed in a plurality of AF regions in the field angle of the captured image.

### Fourth Embodiment

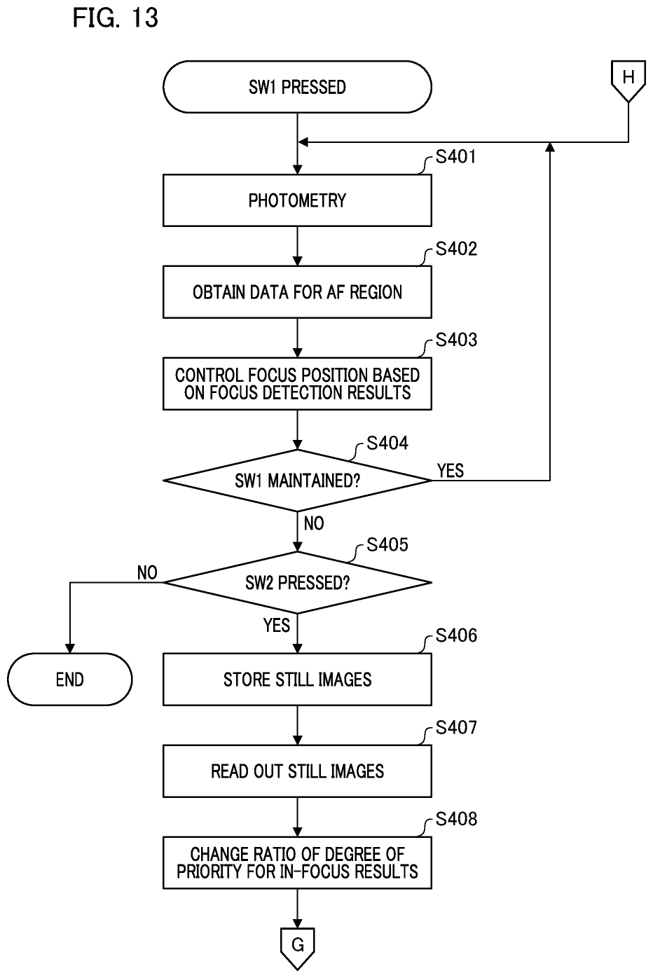

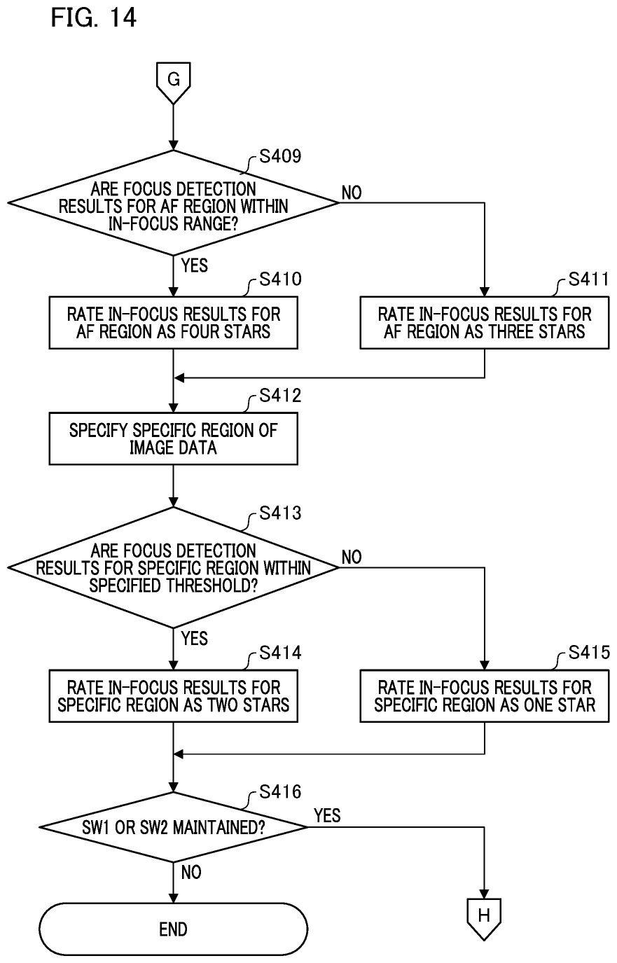

The fourth embodiment of the present invention will be described with reference to FIG. 13 and FIG. 14. In the above embodiments, an example is shown with respect to the focusing results of both the AF region and the specific region in which a two-star rating is provided if the target region is in-focus and a one-star rating is provided if the target region is not in-focus. However, there may be a case in which the image that is close to the user's request differs depending on the subject and composition. For example, the image for which the rating corresponding to the in-focus results of the AF region is two-stars and the rating corresponding to the in-focus results of the specific region is two-stars is defined as the first image. Additionally, the image for which the rating corresponding to the in-focus results of the AF region is two-stars and the rating corresponding to the in-focus results of the specific region is one-star is defined as the second image. In the case in which the object that the user wants to capture an image of exists in the AF region and the specific region, and it is preferable that these regions are in-focus, the first image is selected. In the case in which the object that the user wants to capture an image of exists only in the AF region, and the user wants to capture an intentionally blurred image in which the specific region is not in focus, the second image is selected. Thus, in the present embodiment, an example of a configuration in which the degree of priority for the AF region and the specific region can be set according to the in-focus results thereof will be described.

FIG. 13 and FIG. 14 are flowcharts showing the process in the present embodiment. Since the processes from S401 to S407 are the same as those from S101 to S107 in FIG. 6 in the first embodiment, descriptions thereof will be omitted.

In S408, the user performs the operations for setting the degree of priority according to the in-focus results for the AF region acquired in S402 and the specific region obtained in S412 (FIG. 14). The controller 121 receives the instructions from the user's operation and determines the ratio of the degree of priority for the AF region and the specific region. For example, a case is assumed in which the object that the user would like to be in focus exists to some extent not only in the AF region but also in the specific region. In this case, a process that sets the degree of priority according to the in-focus results of the specific region as being relatively high is performed. In contrast, a case in which the user would like to record an object in the specific region as a blurred image is assumed. In this case, a process that sets the priority according to the in-focus results of the specific region as being relatively low is performed. However, in both cases, it is assumed that the degree of priority according to the in-focus results of the AF region is higher than the degree of priority according to the in-focus results of the specific region. After S408, the process proceeds to S409 in FIG. 14.

In S409, the controller 121 determines whether or not the defocus amount calculated as the focus detection results is within a predetermined in-focus range (for example, −1 Fδ to +1 Fδ [μm]). Specifically, the controller 121 determines whether or not the RAW data and the still image data acquired in S407 are image data in which the object intended by the user is in focus. If it is determined that the defocus amount acquired in S402 is within a predetermined in-focus range, the process proceeds to S410, and if it is determined that the defocus amount is not within the predetermined in-focus range, the process proceeds to S411.

In S410, the controller 121 performs rating based on the absolute value of the defocus amount on the RAW data and the still image data acquired in S407. The rating data acquired as a result of this rating are recorded in the first attribute region of the RAW data and the still image data.

In the present embodiment, as an example of the ratings, four-stars are set when an in-focus state has been attained (a state within a predetermined focusing range) and three-stars are set when an out-of-focus state has been attained. In S410, the controller 121 performs control to record the rating data with four-stars in the first attribute region, and subsequently the process proceeds to S412. Additionally, in S411, the controller 121 performs control to record the rating data with three-stars in the first attribute region, and subsequently the process proceeds to S412.

Hence, according to the present embodiment, the controller 121 performs control to evaluate the still image data based on the focus detection state of the obtained still image data and to record the evaluation information in association with the still image data.

In S412, the user specifies a region (specific region) in the RAW data and the still image data that have been obtained for which they would like to determine whether or not an in-focus state has been attained, using the operation switch group 132. The controller 121 receives the specification operation by the user.

In S413, the controller 121 determines whether or not the defocus amount calculated as a result of the focus detection for the region specified in S412 is within the specified threshold range, as in the case of S409. Specifically, the controller 121 determines whether or not the RAW data and the still image data acquired in S407 are image data in which the region specified by the user is in focus. If it is determined that the defocus amount in the specific region is within the specified threshold range, the process proceeds to S414, and if it is determined that the defocus amount s not within the specified threshold range, the process proceeds to S415.

In S414 and S415, rating processing based on the absolute value of the defocus amount of the region specified by the user in S412 is executed for the RAW data and the still image data obtained in S407. The rating data acquired as a result of this rating are recorded in the second attribute region of the RAW data and the still image data.

In S414, the controller 121 performs control to record the rating data with two-stars in the second attribute region, and subsequently the process proceeds to S416. In S415, the controller 121 performs control to record the rating data with one-star in the second attribute region, and subsequently the process proceeds to S416. Thus, according to the present embodiment, the controller 121 evaluates the still image data based on the focus detection states of two or more regions of the obtained still image data and performs control to record the evaluation information in association with the still image data.

In S416, the controller 121 performs determination regarding the operation input states of the SW1 and the SW2, as in S115 in FIG. 7. If the determination condition is satisfied, the process returns to S401 in FIG. 13 to continue the process, and if the determination condition is not satisfied, the process ends.

According to the present embodiment, it is possible to easily perform the selection of an image that is close to the user's request in terms of the in-focus results of the main object and the other objects (for example, sub-objects). Note that although a mode in which the user can specify the degree of priority according to the in-focus results of the AF region and the specific region has been exemplified, the present invention is not limited thereto. For example, a configuration may be adopted in which the degree of priority may be automatically set such that higher priority is given to the in-focus results of the AF region than the in-focus results of the specific region. Alternatively, the degree of priority can be automatically set according to the image capturing mode, scene, or the like.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed. exemplary embodiments. The scope of the following claims is to be accorded the broadest interpretation so as to encompass all such modifications and equivalent structures and functions.

This application claims the benefit of Japanese Patent Application No. 2021-097123, filed Jun. 10 2021, which is hereby incorporated by reference herein in its entirety.

What is claimed is:

1. An image processing apparatus that acquires image data and depth information related to an image and performs processing comprising:
at least one processor and/or circuit configured to function as the following units:
an acquisition unit configured to acquire information about a first region in an image with respect to the image data;
a determination unit configured to determine a second region, which is different from the first region, to serve as a specific region, in the image; and
a generation unit configured to evaluate a focus state with respect to the image data based on depth information corresponding to each of the first region and second region, and generate a plurality of items of evaluation information,
wherein one rating datum based on the plurality of items of evaluation information is recorded in association with one image.

The image processing apparatus according to claim 1,
wherein the generation unit generates first evaluation information if an in-focus state is attained in the first region and the generation unit generates second evaluation information if an out-of-focus state is attained in the first region.

3. The image processing apparatus according to claim 1,
wherein the generation unit generates first evaluation information if a first focus state has been attained in the second region and the generation unit generates second evaluation information if a second focus state has been attained in the second region.

4. The image processing apparatus according to claim 3,
wherein the first focus state is a state in which a focus detection result is within a threshold range, and the second focus state is a state in which the focus detection result is not within the threshold range.

5. The image processing apparatus according to claim 1,
wherein the depth information is information based on phase difference detection, contrast information of the image data, or the ToF method.

6. The image processing apparatus according to claim 1,
wherein the processor further functions as a detection unit configured to detect a line-of-sight position relative to the image, and
wherein the determination unit determines the second region based on the line-of-sight position detected by the detecting unit.

7. The image processing apparatus according to claim 1,
wherein the determination unit determines the second region according to an operational input relative to the image.

8. The image processing apparatus according to claim 1,
wherein the processor further functions as an object detection unit configured to perform detection processing of an object in the image, and
wherein the determination unit determines the second region based on the position of the detected object in the image.

9. The image processing apparatus according to claim 1,
wherein the generation unit sets the degree of priority of the evaluation information based on the depth information corresponding to the first region higher than the degree of priority of the evaluation information based on the depth information corresponding to the second region.

10. The image processing apparatus according to claim 1,
wherein the generation unit changes the ratio of the degree of priority between the evaluation information based on the depth information corresponding to the first region and the evaluation information based on the depth information corresponding to the second region.

11. The image processing apparatus according to claim 10,
wherein the generation unit generates first evaluation information if an in-focus state has been attained in the first region, the generation unit generates second evaluation information if an out-of-focus state has been attained in the first region, the generation unit generates third evaluation information if a first focus state has been attained in the second region, and the generation unit generates fourth evaluation information if a second focus state has been attained in the second region.

12. The image processing apparatus according to claim 11,
wherein the first focus state is a state in which the focus detection result is within a threshold range, and the second focus state is a state in which the focus detection result is not within the threshold range.

13. An image pickup apparatus comprising:
an image pickup sensor;
at least one processor and/or circuit configured to function as the following units:
an acquisition unit configured to acquire information about a first region in an image with respect to the image data;
a determination unit configured to determine a second region, which is different from the first region, to serve as a specific region, in the image; and
a generation unit configured to evaluate a focus state with respect to the image data based on depth information corresponding to each of the first region and the second region, and generate a plurality of items of evaluation information,
wherein one rating datum based on the plurality of items of evaluation information is recorded in association with one image.

14. The image pickup apparatus according to claim 13,
wherein the image pickup sensor is provided with a plurality of micro lenses and a plurality of photoelectric conversion units corresponding to each micro lens, and acquires a signal used for focus detection of an imaging optical system from the plurality of photoelectric conversion units corresponding to the first region.

15. An image processing method executed by an image processing apparatus that acquires image data and depth information related to an image and performs processing, the method comprising:
acquiring information about a first region in an image with respect to the image data;
determining a second region, which is different from the first region, to serve as a specific region, in the image;
performing evaluation of a focus state with respect to the image data based on depth information corresponding to each of the first and second regions and generating a plurality of items of evaluation information; and
recording one rating datum based on the plurality of items of evaluation information in association with one image.

16. A non-transitory storage medium on which a computer program for causing a computer of an image processing apparatus that acquires image data and depth information related to an d performs processing is stored to execute an image processing method, the method comprising:
acquiring information about a first region in an image with respect to the image data;
determining a second region, which is different from the first region, to serve as a specific region, in the image;
performing evaluation of a focus state with respect to the image data based on depth information corresponding to each of the first and second regions and generating a plurality of items of evaluation information; and
recording one rating datum based on the plurality of items of evaluation information in association with one image.
